(19) United States
(12) Patent Application Publication
(10) Pub. No.: US 2003/0034967 A1
(43) Pub. Date: Feb. 20, 2003

(54) Liquid cryastal display device

(76) Inventor: Yoshihiro Imajo, Mobara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/212,247

(22) Filed: Aug. 6, 2002

(30) Foreign Application Priority Data
Aug. 16, 2001 (JP) 2001-247284

(51) Int. Cl. G09G 5/00; G09G 3/36

(52) U.S. Cl. 345/211; 345/103

(57) ABSTRACT

In a liquid crystal display device juxtaposing a plurality of semiconductor chips on a peripheral edge of one of a pair of substrates between which a liquid crystal layer is interposed and transferring digital signals between the semiconductor chips adjacent to one another, the present invention provides a power terminal supplying source voltage for each of the semiconductor chips which is formed to be extended along a juxtaposition thereof and connects the respective power terminals to wiring layers for electricity supply formed on the one of a pair of substrates and spaced from one another, so that electric resistance of the source voltage supply between the semiconductor chips can be reduced without attaching any circuit board to the one of the pair of substrates.

### BACKGROUND OF THE INVENTION

1. Field of the Invention

The present invention relates generally to liquid crystal display devices and, more particularly, to techniques effectively applicable to drive circuitry of a liquid crystal display device of the type employing a scheme for transferring a digital signal between drive circuits (drain drivers).

2. Description of the Related Art

Liquid crystal display modules of the type using the so-called super twisted nematic (STN) scheme or thin-film transistor (TFT) scheme and having a large-size color liquid crystal display panel with a pixel number of 800×480×3 or greater by way of example are widely used as display devices for notebook type personal computers or the like. These liquid crystal display devices of the type stated above comprise a liquid crystal display panel and drive circuitry for driving the liquid crystal display panel.

And, in such liquid crystal display devices, one is known which is of the type using a scheme (hereinafter referred to as digital signal sequential transfer scheme) for inputting a digital signal (e.g. display data or clock signal) only to the first or “top” drive circuit of cascade-connected drive circuits while sequentially transferring the digital signal to the remaining drive circuits through the inside of drive circuits in a way as disclosed, for example, in Published Unexamined Japanese Patent Application No. 6-13724 (“JP-A-6-13724”).

With the liquid crystal display device disclosed in the above-identified official gazette JP-A-6-13724, semiconductor integrated circuit (IC) devices which constitute the drive circuitry are directly mounted on a glass substrate of a liquid crystal display panel.

### SUMMARY OF THE INVENTION

FIG. 8 is a block diagram showing a basic configuration of the liquid crystal display panel in one prior art liquid crystal display device of the type employing the above-stated digital signal sequential transfer scheme.

As shown herein, with a liquid crystal display panel in the prior art liquid crystal display device employing the above-noted digital signal sequential transfer scheme, a timing controller (or display control device) 110 and drain drivers 130 plus gate drivers 140 are mounted at peripheral portions of two sides of an optically transparent dielectric substrate (glass substrate) which makes up a TFT substrate of the liquid crystal display panel 100, respectively.

A digital signal (display data, clock signal or else) which was sent out of the timing controller 110 and a gray-scale reference voltage (also called, “a color gradation reference voltage”) being supplied from a power source circuit are input to each drain driver 130 in such a way that these are first input to the top drain driver 130 and then transferred through an internal signal line within each drain driver 130 and along a transfer line path (wiring layer on or above the glass substrate) between respective drain drivers 130.

A power supply voltage of each drain driver 130 is supplied from a power source circuit 120 through a flexible printed wiring board (simply referred to hereinafter as “FPC” board) 150 to each drain driver 130.

Similarly the digital signal (clock signal or the like) which is sent out of the timing controller 110 is input to each gate driver 140 in such a way as to be input to a top gate driver 140 and then transferred over an internal signal line within each gate driver 140 and along a transfer line path (wiring layer above the glass substrate) between respective gate drivers 140.

It should be noted that on the gate driver side, the power supply voltage of gate drivers 140 as supplied from the power source circuit 120 also is supplied to the top gate driver 140 and then supplied to each gate driver 140 via the internal power line within each gate driver 140 and a transfer line path (wiring layer above the glass substrate).

In this way, in the liquid crystal display device of the type employing the digital signal sequential transfer scheme, both the display data and the clock signal which are sent out of the timing controller are sequentially transferred to each one of the cascade-connected drivers through the signal line of each driver (drain driver 130, or gate driver 140) and the transfer line path (wiring layer above the glass substrate) between respective drivers.

However, the power supply voltage to be supplied to the drain drivers 130 is supplied to each drain driver 130 individually (or in parallel fashion) through the FPC board 150.

On the other hand, although liquid crystal display devices are under strict requirement for achievement of low costs, the liquid crystal display device employing the above-stated digital signal sequential transfer scheme is encountered with a problem that it is difficult to attain further cost reduction because the above-mentioned FPC board 150 is inherently high in production cost.

The present invention has been made in order to solve the problem faced with the prior art, and an object of this invention is to provide, in the liquid crystal display device employing the digital signal sequential transfer scheme, a technique for enabling the cost to become lower than the prior art.

The aforesaid and other objects and new features of the present invention will become apparent from the description of this specification and its accompanying drawings attached thereto.

Briefly described below are representative examples of the invention disclosed in this application.

A liquid crystal display device according to one of aspects of the present invention comprises: a first substrate; a second substrate; and liquid crystals interposed between the first and second substrates,

wherein the first substrate has a plurality of semiconductor chips mounted on at least peripheries thereof at two adjacent sides thereof, and

at least one of the plurality of semiconductor chips has a power terminal supplying source voltage for a circuit element in the semiconductor chip which is formed to be extended along one direction.

In one of examples for applying the present invention preferably to the above-described liquid crystal display device,

the plurality of semiconductor chips are divided into a first group mounted on a periphery of the first substrate along a first side thereof and a second group mounted on another periphery of the first substrate along a second side thereof,

the respective semiconductor chips belonging to the first group have power terminals for supplying source voltage for circuit elements disposed in the semiconductor chips respectively, which are formed to be extended along a direction in which the semiconductor chips of the first group are arranged,

a wiring layer for electricity supply formed to be extended along the first side thereof and divided by areas on which the respective semiconductor chips belonging to the first group are mounted, and

both end of the power terminal of each of the semiconductor chips belonging to the first group are connected to the wiring layer for electricity supply, respectively.

Moreover, a liquid crystal display device according to another of aspects of the present invention comprises: a first substrate; a second substrate; and liquid crystals interposed between the first and second substrates,

wherein the first substrate has a plurality of semiconductor chips mounted on at least two adjacent peripheral sides of the first substrate and a pair of wiring layers for electricity supply provided to be extended and spaced from one another in an area of the first substrate where one of the plurality of semiconductor chips is mounted,

the one of the semiconductor chips has a power terminal supplying source voltage for a circuit element disposed therein being extended along a direction in which the one of the semiconductor chips and another of the semiconductor chips adjacent thereto are arranged, and

both ends of the power terminal provided for the one of the semiconductor chips are connected to the pair of wiring layers for electricity supply.

Furthermore, a liquid crystal display device according to the other one of aspects of the present invention comprises: a liquid crystal display element having a first substrate, a second substrate, and liquid crystals interposed between the first and second substrates; and a frame-shaped upper case having an opening exposing one of main surfaces of the second substrate of the liquid crystal display element as a display area,

wherein the first substrate has a plurality of semiconductor chips mounted respectively on at least peripheries of the first substrate along its two adjacent sides,

a thermal conductive film formed of a material having high thermal conductivity (e.g. a high thermal conductive rubber) is provided between a surface of each of the plurality of semiconductor chips opposite to its another surface facing the first substrate and the upper case.

### BRIEF DESCRIPTION OF THE DRAWINGS

FIG. 1 is a block diagram showing a basic configuration of a display panel of a liquid crystal display module of an embodiment 1 of the present invention;

FIG. 2 is a block diagram showing one exemplary schematic internal configuration of a drain driver shown in FIG. 1;

FIG. 3 is a diagram showing a pictorial representation for explanation of a bump electrode formation surface of the drain driver of the embodiment of this invention and a wiring layer above a glass substrate constituting a TFT substrate;

FIG. 4 is a main-part cross-sectional diagram showing the state that the drain driver of the embodiment of the invention is mounted on the glass substrate making up the TFT substrate;

FIG. 5 is a diagram showing a pictorial representation for explanation of a bump electrode formation surface of a modified example of the drain driver of the embodiment of the invention;

FIG. 6 is an exploded perspective view for showing a schematic arrangement of a liquid crystal display module of the embodiment of the invention;

FIG. 7 is a pictorial representation diagram showing other features of the liquid crystal display module embodying the invention; and

FIG. 8 is a block diagram showing a basic configuration of a display panel of one prior art liquid crystal display module.

### DETAILED DESCRIPTION

One preferred embodiment of the present invention will be explained in detail with reference to the accompanying drawings below.

Note that in all the drawings for explanation of the embodiment, parts having similar functions are designated by the same reference characters with a repetitive explanation thereof eliminated.

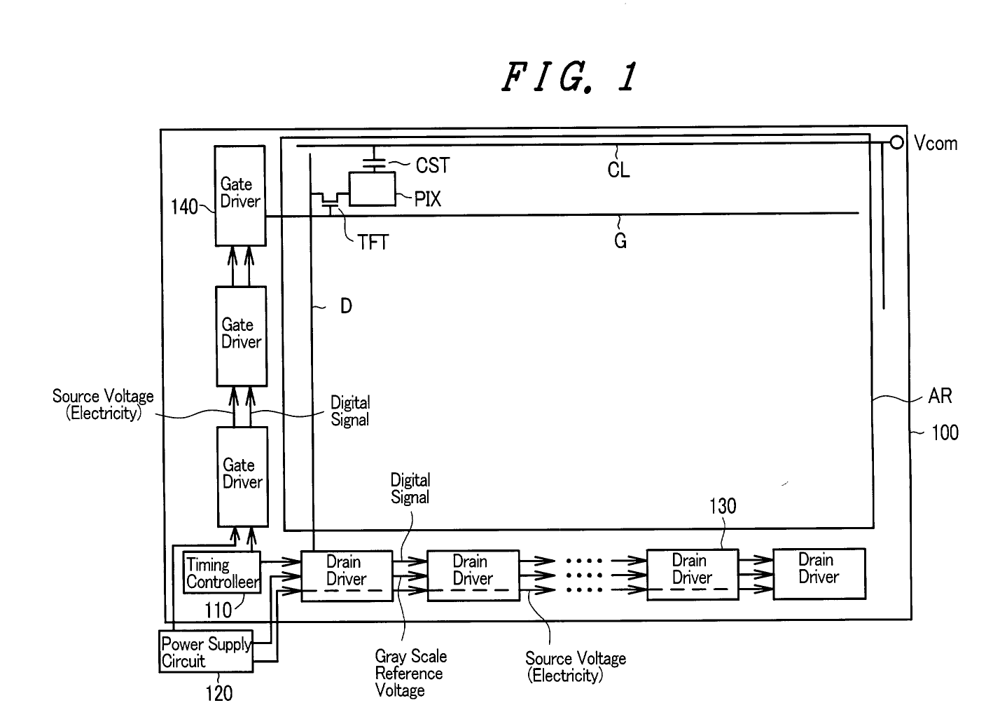

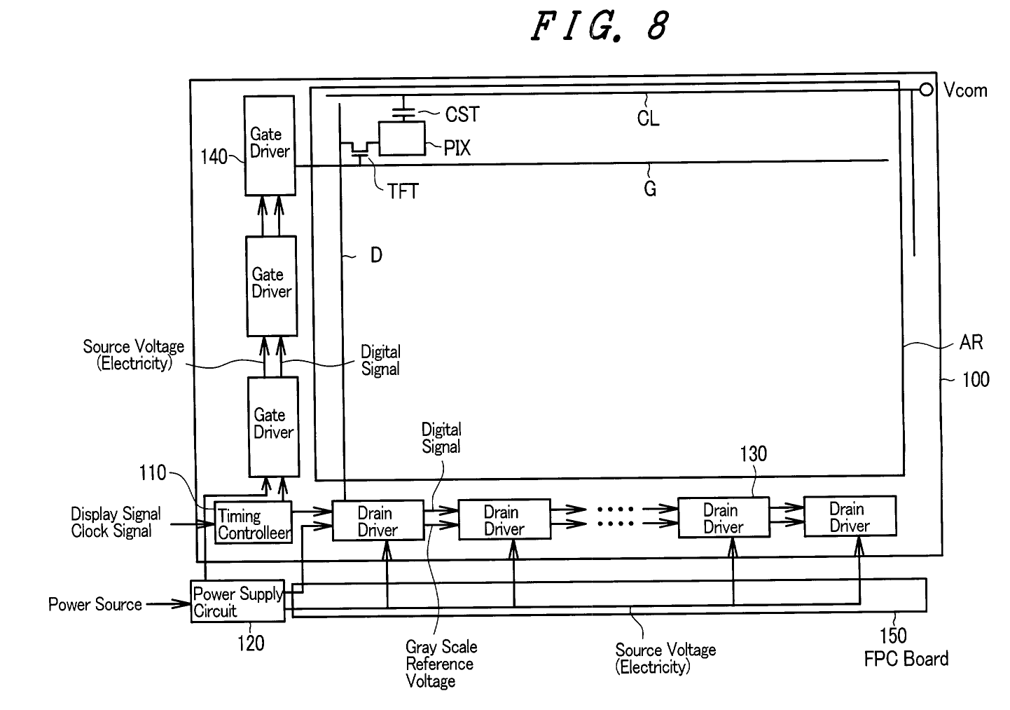

FIG. 1 is a block diagram showing a principal configuration of a liquid crystal display panel of a liquid crystal display module in accordance with an embodiment of the present invention. Note that in FIG. 1 and FIG. 8, “AR” is used to indicate an effective display region.

The liquid crystal display panel 100 is arranged by superposing a TFT substrate on which pixel electrodes PIX and thin-film transistors (TFTs) and others are formed and a filter substrate on which a counter electrode and color filter or else are formed with a prespecified spacing or interval defined therebetween, pasting the both substrates together by use of sealing material which is provided to have a rectangular frame-like shape at a portion adjacent to the periphery between the both substrates, filling a liquid crystal material into the inside of the sealing material from more than one liquid crystal sealing inlet port as provided at part of the sealing material to thereby seal the liquid crystal inside the sealing material between the substrates, and further adhering a polarizer plate(s) to outside of the both substrates.

Respective picture elements or “pixels” each have a pixel electrode PIX and a thin-film transistor (TFT) and are provided in a way corresponding to portions at which a plurality of scan signal lines (or gate signal lines) G and image signal lines (or drain signal lines) D cross together.

It is noted here that in the illustrative embodiment, a holding or retaining capacitor CST is provided on a per-pixel basis in order to maintain a voltage potential of the pixel electrode PIX; additionally, CL is used to denote a capacitance line for supplying a reference voltage Vcom to the holding capacitor CST.

Further note that although in FIGS. 1 and 8 only a single component is depicted as the pixel electrode PIX, the pixel electrode PIX and the thin-film transistor (TFT) plus the holding capacitor CST are such that multiple ones are provided in a matrix form. Optionally the capacitance line CL may be replaced with a scan signal line G of its previous line.

The thin-film transistor (TFT) of each pixel has its source connected to a pixel electrode PIX, a drain connected to an image signal line D, and a gate coupled to a scan signal line G, and thus functions as a switch for supplying a display voltage (a gray scale voltage or a color gradation voltage) to the pixel electrode PIX.

Note that the names “source” and “drain” are sometimes reversed in relation to a bias used—here, the one that is coupled to the image signal line D is called the drain.

A timing controller 110, drain drivers 130 and gate drivers 140 are mounted at peripheral portions of two neighboring sides of a transparent dielectric substrate (glass substrate) which makes up the TFT substrate of the liquid crystal display panel 100, respectively.

And, as described previously, a digital signal (display data, clock signal or the like) to be sent out of the timing controller 110 and a gray scale or color gradation reference voltage being supplied from a power source circuit are input to each drain driver 130 in such a way as to be input to a first or “top” one of the drain drivers 130 and then transferred through an internal signal line within each drain driver 130 and along a transfer path (wiring layer above the glass substrate) between respective drain drivers 130.

It must be noted that in this embodiment, a power supply voltage of each drain driver 130 also is supplied to each drain driver 130 from a power source circuit 120 through a wiring layer (power-use wiring layer) between respective drain drivers 130 and bump electrodes which are formed on one principal or “main” surface of drain driver 130 in a manner as will be described later. In brief, with this embodiment, the FPC board 150 shown in FIG. 8 is omitted.

In addition, the digital signal (clock signal or else) as sent out of the timing controller 110 is input to each gate driver 140 in such a way that the signal is input to the top gate driver 140 and is sent forth via the internal signal line within each gate driver 140 and along a transfer line path (wiring layer above the glass substrate) between respective gate drivers 140.

Additionally a power supply voltage of gate driver 140 to be supplied from the power source circuit 120 is input to each gate driver 140 in such a way that it is first supplied to the top gate driver 140 and then supplied through an internal power supply line within each gate driver 140 and a wiring layer (power-use wiring layer) between respective gate drivers 140.

The timing controller 110 is made up of a single semiconductor integrated circuit (LSI) for controlling and driving the drain drivers 130 and gate drivers 140 based on respective control signals and display data (R, G, and B) which are sent from a computer main body side, wherein the display control signals include a clock signal, display timing signal, horizontal synchronizing signal, and vertical synchronizing signal.

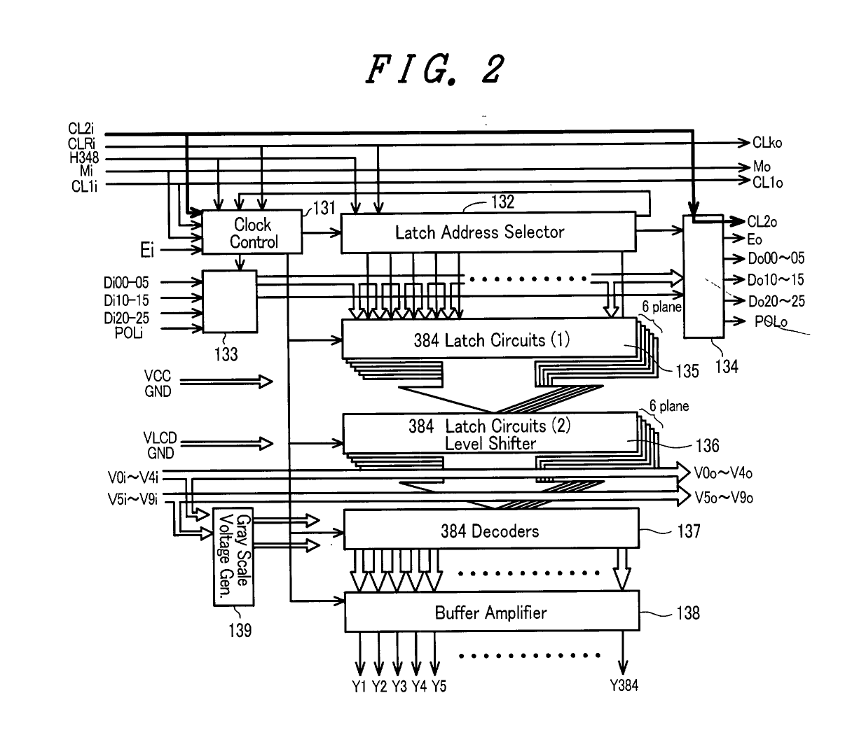

FIG. 2 is a block diagram showing one exemplary schematic internal configuration of the drain driver 130 shown in FIG. 1. Note that in FIG. 2, suffix “i” is used to mean an externally input signal whereas suffix “o” means a signal which is transferred within the drain driver 130 and then output toward the outside.

For example, CL2i designates a display data latching clock signal to be input from the outside whereas CL2o is a display data latch clock signal which is transmitted through the inside of drain driver 130 and then output to the outside (a drain driver 130 at the next stage).

A latch circuit (1) 135 shown in FIG. 2 is operable based on a data accept signal being sent out of a latch address selector 132 to sequentially latch the display data to be sent out of a data accepting arithmetic circuit 133.

Note that the display data being sent out of the data accept arithmetic circuit 133 will be externally output via a data output circuit 134.

Here, the latch address selector 132 generates the data accept signal based on a display data latching clock signal (CL2; hereinafter, simply referred to as clock signal (CL2)) which is sent out of a clock control circuit 131.

Based on an output timing control clock (CL1) as sent out of the clock control circuit 131, a latch circuit (2) 136 receives and accepts the display data being presently latched at the latch circuit (1) 135 and then outputs it to a decoder circuit 137.

The decoder circuit 137 selects a gray-scale/color-gradation voltage corresponding to the display data as sent out of the latch circuit (2) 136 from among 64 gradation levels (64 gray scale levels) of the gradation voltage (the gray scale voltage) to be supplied from a gradation voltage generating circuit (also called, a gray scale voltage generating circuit) 139, and then outputs it to an amplifier circuit 138.

The amplifier circuit 138 amplifies (current-amplifies) the gradation voltage as sent out of the decoder circuit 137 and then supplies it to each drain signal line D.

The gate driver 140 sequentially supplies, based on a frame start instruction signal (FLM) as sent from the timing controller 110 along with a shift clock (CL3), a select scan voltage of High level to each gate signal line G of the liquid crystal display panel 100 with respect to every single horizontal scan time period.

Whereby a plurality of thin-film transistors (TFTs) which are connected to respective gate signal lines G of the liquid crystal display panel 100 are rendered conductive within one horizontal scan time period, causing the gradation voltage (the gray scale voltage) as supplied from the amplifier circuit 138 to be applied to each pixel electrode PIX; thus, an image is displayed on the liquid crystal display panel 100.

In addition, the gradation voltage generator circuit 139 generates a positive gradation voltage having 64 gradation levels based on positive gradation reference voltages (V0 to V4) as supplied from the outside and also generates a negative gradation voltage with 64 gradation levels based on negative gradation reference voltages (V5 to V9) being supplied from the outside.

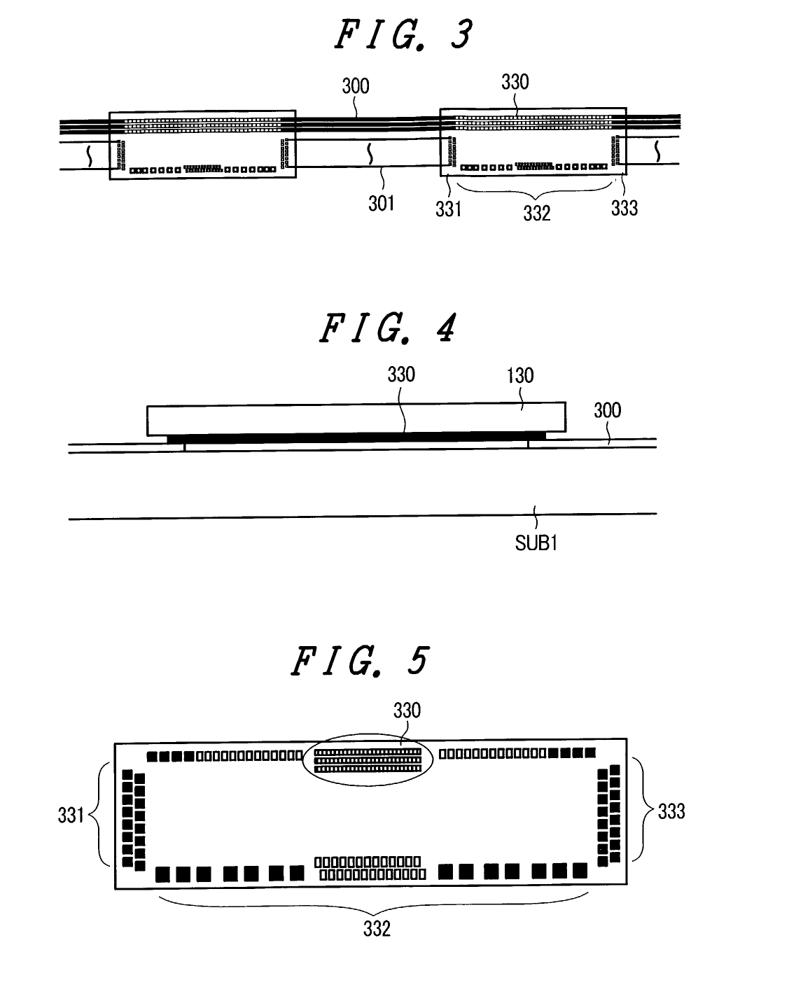

FIG. 3 is a diagram showing a pictorial representation for explanation of a bump electrode formation surface of the drain driver 130 of this embodiment and a wiring layer above a glass substrate which makes up the TFT substrate, and FIG. 4 is a main-part cross-sectional diagram showing the state that the drain driver 130 of this embodiment is mounted on the glass substrate making up the TFT substrate.

As shown in FIG. 3, in the drain driver 130 of this embodiment, bump electrodes 330 to which power supply voltages are supplied are provided in such a manner as to linearly extend in a direction along which the plurality of drain drivers 130 are laid out.

And as shown in FIGS. 3 and 4, both terminate ends of these extended formed bump electrodes 330 are connected to wiring layers (power supply-use wiring layers) 300 which are formed on a glass substrate (SUB1) making up the TFT substrate.

Accordingly, with this embodiment, the power supply voltages (e.g., voltages of VCC, GND, VLCD shown in FIG. 2) to be supplied from the power source circuit 120 to drain drivers 130 are supplied to the next-stage drain driver 130 through the wiring layers 300 being formed on the glass substrate (SUB1) making up the TFT substrate and bump electrodes 330 of each drain driver 130.

It should be noted that in FIG. 3, numeral 331 designates a bump electrode to which digital signals (e.g. display data of D00-D05, D10-D15, D20-D25 and clock signals such as CL1, CL2 and AC-converted signal (M) or the like as shown in FIG. 2) and gradation reference voltages (e.g. gradation reference voltages of V0-V9 shown in FIG. 2) are input; 333 denotes a bump electrode from which the above-noted digital signals and gradation reference voltages are output. Additionally, 332 indicates bump electrodes which are connected to the drain signal lines D of the liquid crystal display panel 100. Note here that the bump electrodes (331, 333) are connected to portions of a wiring layer 301 that is formed on the glass substrate (SUB1) making up the TFT substrate.

Generally, bump electrodes of a semiconductor chip are such that gold (Au) bumps are used, whose thickness is set at 15 μm, or more or less. In view of the fact that the gold bump electrodes are inherently less in specific resistance or resistivity than aluminum (Al) to be used as wiring layers within the semiconductor chip by way of example and moreover can be made thicker while offering a difference on the order of magnitude of one digit or greater, it is possible to lessen the resistance value of bump electrodes.

For this reason, as shown in FIG. 1, even when the power supply voltage are supplied to each drain driver 130 through the gold bump electrodes which are formed on the bump electrode formation surface of drain driver 130 and the wiring layers 300 overlying the glass substrate (SUB1) without the use of the FPC board 150 shown in FIG. 8, it is possible to reduce any possible variations of the voltage value of the power supply voltage(s) to be supplied to the last-ordered drain driver 130 to a practical use level.

It must be noted that the above-stated gold bump electrodes can be formed simultaneously at a bump electrode formation step in the presently available manufacturing process so that it does not lead to any appreciable cost increase. Furthermore, with this embodiment, it is possible to eliminate the use of the FPC board 150 shown in FIG. 8; thus, it is possible for this embodiment to further reduce production costs.

FIG. 5 is a diagram showing a pictorial representation for explanation of the bump electrode formation surface of a modified example of the drain driver 130 of the embodiment.

Although in a drain driver 130 shown in FIG. 5 also the bump electrodes are formed into a linear array form, this drain driver 130 shown in FIG. 5 is the one in which these bump electrodes are for use as power supply wiring lines (power supply wiring lines within a semiconductor chip) within the drain driver.

Generally, while aluminum is used as power supply wiring lines within the semiconductor chip, this aluminum wiring layer has a thickness of several hundreds of nanometer (nm). In contrast, gold bump electrodes for use as the bump electrodes measure about 15 μm in thickness.

To be brief, since gold bump electrodes are less in resistivity than aluminum (Al) and also can be thickened with a difference on the order of magnitude of one digit or more, it becomes possible to provide extremely low resistance power supply wiring lines, which in turn makes it possible to suppress the influence of the resistance of such power supply lines within the drain driver upon driver outputs, thus enabling an image as visually displayed on the liquid crystal display panel 100 to improve in display quality thereof.

It is noted that although the above explanation is specifically directed to the case where the linear array of gold bump electrodes is provided only on the drain driver side for supplying the power supply voltage(s) to each drain driver 130 via the gold bump electrodes and the wiring layer(s) 300 overlying the glass substrate (SUB 1), the present invention should not be limited to only this arrangement and may alternatively be modified so that the gate driver side is arranged similarly.

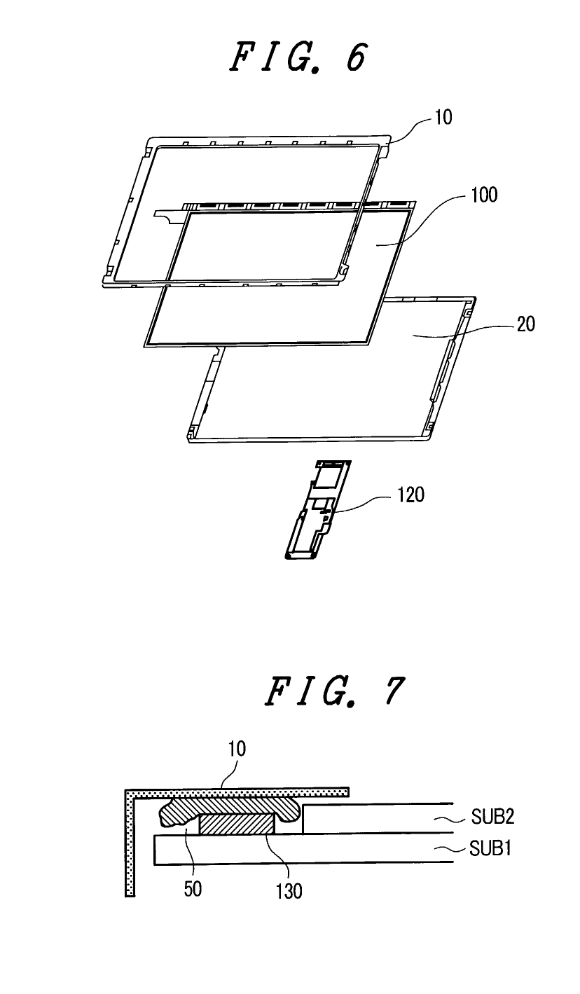

FIG. 6 is an exploded perspective view schematically showing a structure of a liquid crystal display module of the embodiment.

As shown in FIG. 6, the liquid crystal display module of this embodiment is arranged so that its liquid crystal display panel 100 is received between a hollow rectangular casing-like frame (upper side case) 10 formed of a metal plate and a back-light unit 20. In addition, the power source circuit 120 is disposed on the backside of the backlight unit 20.

Note that the backlight unit is generally structured from a cold cathode fluorescent lamp(s), a wedge-shaped (side shape is like a trapezoid) light guide body, a diffusion sheet(s), a prism sheet(s), a reflective sheet(s), and a mold that receives therein the above-noted respective components; however, the structure of this backlight unit per se has no relation to the present invention so that its detailed explanation is omitted herein.

FIG. 7 is a pictorial representation diagram showing other features of the liquid crystal display module of this embodiment.

Note that in FIG. 7, “SUB2” is used to designate a glass substrate which makes up a color filter substrate. Also note that in FIG. 7, only the frame 10 shown in FIG. 6 and its associated part of the liquid crystal display panel 100 are depicted with an illustration of an arrangement therefor eliminated herein.

If power consumption of the drain driver 130 is large, then heat generation of the drain driver 130 increases accordingly. In addition, liquid crystals exhibit certain temperature dependency so that a change in temperature would result in a likewise change in applied voltage versus transmissivity characteristics.

Due to this, it is assumed that upon application of the heat created at the above-noted drain driver 130 to the liquid crystals of the liquid crystal display panel 100, the applied voltage vs transmissivity characteristics of such part changes resulting in occurrence of luminance irregularities on an image display screen of the liquid crystal display panel 100.

However, with this embodiment, a heat conductive film 50 which is made of high thermal conductivity material such as for example high thermal conductive rubber or the like is provided between an opposite side surface to the bump electrode formation surface of the drain driver 130 and the frame 10.

With such an arrangement, in this embodiment, even when the power consumption of the drain driver 130 increases resulting in an increase in heat generation of drain driver 130, it becomes possible to conduct the heat created at this drain driver 130 to the metallic frame 10 through the heat conductive film 50 to thereby effectively release the heat by the frame 10.

Due to this, with this embodiment, it becomes possible to prevent occurrence of any unwanted local luminance irregularities on the display screen of the liquid crystal display panel 100 otherwise occurring due to the heat generation at the drain driver 130, thus making it possible to improve the display quality of on-screen images being displayed on the liquid crystal display panel 100.

Although the invention made by the present inventor has been explained in detail based on the aforesaid embodiment thereof, it is apparent that the present invention should not be limited only to said embodiment and may be modified and altered in a variety of forms without departing from the scope of the invention.

A brief explanation of an effect obtainable by a representative one of the inventive concepts disclosed herein is as follows.

In accordance with the present invention, in a liquid crystal display device of the type employing the digital signal sequential transfer scheme, it becomes possible to reduce the cost than the prior art.

What is claimed is:

1. A liquid crystal display device, comprising:
a first substrate;
a second substrate; and
liquid crystals interposed between the first and second substrates,
wherein the first substrate has a plurality of semiconductor chips mounted on at least peripheries thereof at two adjacent sides thereof, and
at least one of the plurality of semiconductor chips has a power terminal supplying source voltage for a circuit element in the semiconductor chip which is formed to be extended along one direction.

2. A liquid crystal display device, comprising:
a first substrate;
a second substrate; and
liquid crystals interposed between the first and second substrates,
wherein the first substrate has a plurality of semiconductor chips mounted on at least two adjacent peripheral sides of the first substrate and a pair of wiring layers for electricity supply provided to be extended and spaced from one another in an area of the first substrate where one of the plurality of semiconductor chips is mounted,
the one of the semiconductor chips has a power terminal supplying source voltage for a circuit element disposed therein being extended along a direction in which the one of the semiconductor chips and another of the semiconductor chips adjacent thereto are arranged, and
both ends of the power terminal provided for the one of the semiconductor chips are connected to the pair of wiring layers for electricity supply.

3. A liquid crystal display device according to claim 1, wherein
the plurality of semiconductor chips are divided into a first group mounted on a periphery of the first substrate along a first side thereof and a second group mounted on another periphery of the first substrate along a second side thereof,
the respective semiconductor chips belonging to the first group have power terminals for supplying source voltage for circuit elements disposed in the semiconductor chips respectively, which are formed to be extended along a direction in which the semiconductor chips of the first group are arranged,
a wiring layer for electricity supply formed to be extended along the first side thereof and divided by areas on which the respective semiconductor chips belonging to the first group are mounted, and
both end of the power terminal of each of the semiconductor chips belonging to the first group are connected to the wiring layer for electricity supply, respectively.

4. A liquid crystal display device, comprising:
a liquid crystal display element having a first substrate, a second substrate, and liquid crystals interposed between the first and second substrates; and
a frame-shaped upper case having an opening exposing one of main surfaces of the second substrate of the liquid crystal display element as a display area,
wherein the first substrate has a plurality of semiconductor chips mounted respectively on at least peripheries of the first substrate along its two adjacent sides,
a thermal conductive film formed of a material having high thermal conductivity is provided between a surface of each of the plurality of semiconductor chips opposite to its another surface facing the first substrate and the upper case.

5. A liquid crystal display device according to claim 4, wherein the thermal conductive film is a high thermal conductive rubber.
